(19) United States
(12) Patent Application Publication
(10) Pub. No.: US 2003/0097406 A1
(43) Pub. Date: May 22, 2003

(54) Method of exchanging messages

(76) Inventor: Ben Stafford, Hampshire (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/987,848

(22) Filed: Nov. 16, 2001

(51) Int. Cl. G06F 15/16

(52) U.S. Cl. 709/204

(57) ABSTRACT

First and second personal computer systems exchange messages using message exchange software. A message exchange interface window is displayed on a monitor of each computer. The window includes a message board for displaying messages, a text editor for entering and editing messages, a send button for posting a message to the message board and a plurality of predefined messages. The predefined messages allow users to communicate more quickly and converse more fluidly.

### FIELD OF THE INVENTION

The present invention relates to a method of exchanging messages, particularly, although not exclusively, text messages.

### BACKGROUND ART

It is known in the art to exchange text messages or conduct so-called “chat” via a message board over a communications network. For example, Yahoo!™ provides chat rooms, each relating to a different topic of conversation, which participants can access via the Internet and view using a web-browser run on a personal computer (PC). Each participant is able to view a copy of a chat board which displays messages posted by participants. Thus, if a first participant posts a message to the chat board, then the message, together the identity of the first participant, is displayed on the chat board and viewed by other participants. A second participant having read the message can respond by posting a reply. The first participant, in turn, can send another response. Thus, a sequence of messages is displayed on the chat board. In this way, two or more participants can engage in a real-time, text-based conversation.

Business-orientated conferencing systems, such as Microsoft NetMeeting™, operate in a substantially similar way, although a text-based message board can be supplimented by voice and video clips.

Chat is not just limited to computer-based networks. Chat can be conducted over telecommunications networks using mobile telephone handsets. For example, a Nokia 3310 handset provides a chat messaging feature.

Current message exchange software suffers from the drawback that a participant, having posted a message, is unsure whether they can expect a reply. For example, a first user posts a message “Hey, let's meet”. A second user intends to answer and begins to prepare a response by typing via keyboard or keypad “OK. Let's meet at the cafe at 8pm”. In the meantime, the first user is left waiting. At best, this delay is an inconvenience. At worst, the delay may cause the first user to end the conversation because they decide that the second user is not going to reply.

The present invention seeks to help provide a solution to this problem.

### SUMMARY OF THE INVENTION

According to the present invention there is provided a method of exchanging messages using a commonly accessible message board, the method comprising presenting a user with one or more predefined messages and receiving an input from the user selecting one of said predefined messages as a message for posting on said message board.

The method may further comprise posting said message on said message board, which may include sending said message to at least one other user. The sending of said message to at least one other user may comprise transmitting said data over a communications network, the internet a telecommunications network or a local area network and the data can be transmitted as a short message service (SMS) message.

The presenting said user with said one or more predefined messages may comprise outputting graphical representations of said predefined messages to a display, such as displaying selectable icons using a graphical user interface. Each of said selectable icons may include text of a respective message to be posted to said message board. The selecting of said one of said predefined messages may include locating a focus on a one of said selectable icons.

According to the present invention there is also provided a computer program for performing the method.

According to the present invention there is also provided an electronic device for exchanging messages using a commonly accessible message board, the device configured to present a user with one or more predefined messages and to receive an input from the user selecting one of said predefined messages as a message for posting on said message board.

The device can be a computer or a mobile communications device, such as a mobile telephone handset.

According to the present invention there is still further provided a method of exchanging text messages comprising receiving a message and responding to the message by (a) selecting a predefined message and sending it, and thereafter (b) composing a non-predefined message and sending it.

The sending of said messages may comprise sending said messages to a user. The sending of said messages may comprise posting said messages to a commonly accessible message board.

According to the present invention there is also provided an electronic device for exchanging text messages, the device configured to receive a message and to respond to the message by permitting the user to select a predefined message and send it, and thereafter compose a non-predefined message and send it.

### BRIEF DESCRIPTION OF THE DRAWINGS

Embodiments of the present invention will now be described, by way of example, with reference to the accompanying drawings in which:

FIG. 1 shows a plurality of computer systems connected by a communications network according to a first embodiment of the present invention;

FIG. 2 shows a computer system including a display monitor;

FIGS. 3 to 5 show a message exchange window including a message board displaying successive messages;

FIG. 6 shows a plurality of mobile telephone handsets connected by public land mobile network according to a second embodiment of the present invention;

FIG. 7 shows a mobile telephone handset;

FIGS. 8 to 14 show outputs displayed on a mobile telephone handset.

### PREFERRED EMBODIMENTS OF THE INVENTION

### First Embodiment

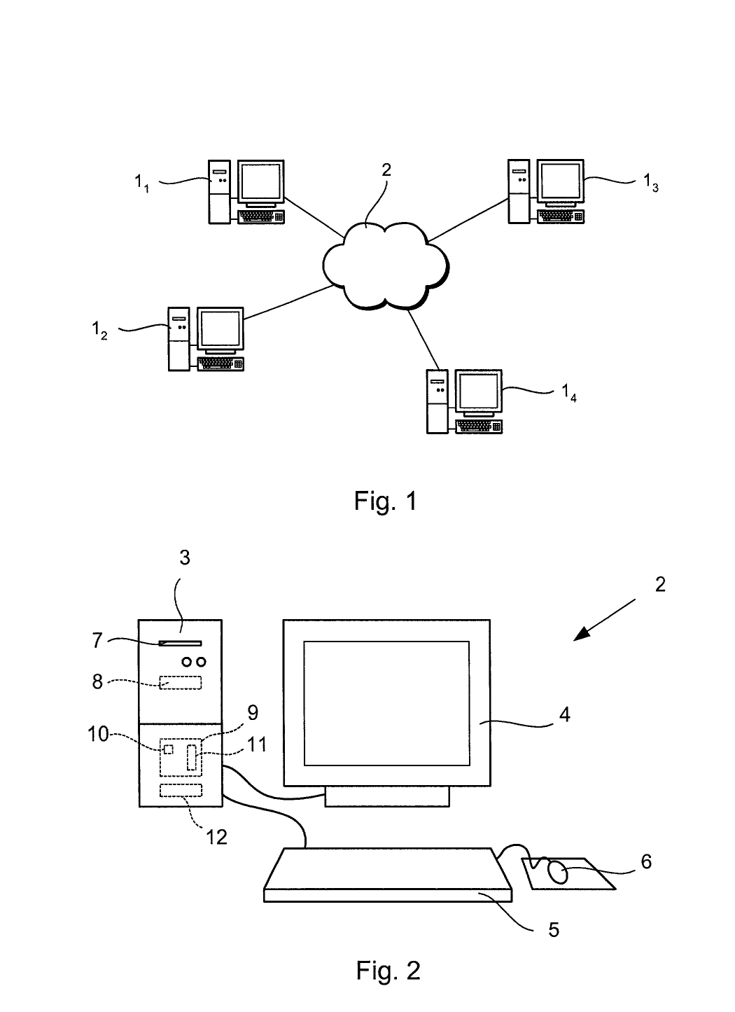

Referring to FIG. 1, a plurality of personal computer systems 1₁, 1₂, 1₃, 1₄ are connected via a communications network 2. In this example, the computer systems 1₁, 1₂, 1₃, 1₄ are connected by means of the Internet in a manner well known per se.

Referring to FIG. 2, a typical personal computer system 1 comprises a computer 3, a display monitor 4, a keyboard 5 and mouse 6. The computer 3 houses hardware including a CD drive 7, a hard disk drive 8, a motherboard 9 supporting inter alia a processor 10 and random access memory 11. The computer 3 also houses a modem 12 for connection to a public switched telephone network (not shown) via which the computer system 1 is connected to an Internet service provider (not shown). It will be appreciated that the computer system 1 can have other configurations so as to be able to communicate with other computer systems 1. For example, an external modem, cable modem or DSL modem can be used. Local-area network cards or a USB can be employed, for example to connect computers directly together. It will also be appreciated that the personal computer systems 1 need not be the same nor indeed be of the same type. For example, they may be table-top, lap-top or hand-held computers.

A process by which users of first and second computer systems 1₁, 1₂ can exchange messages will now be described.

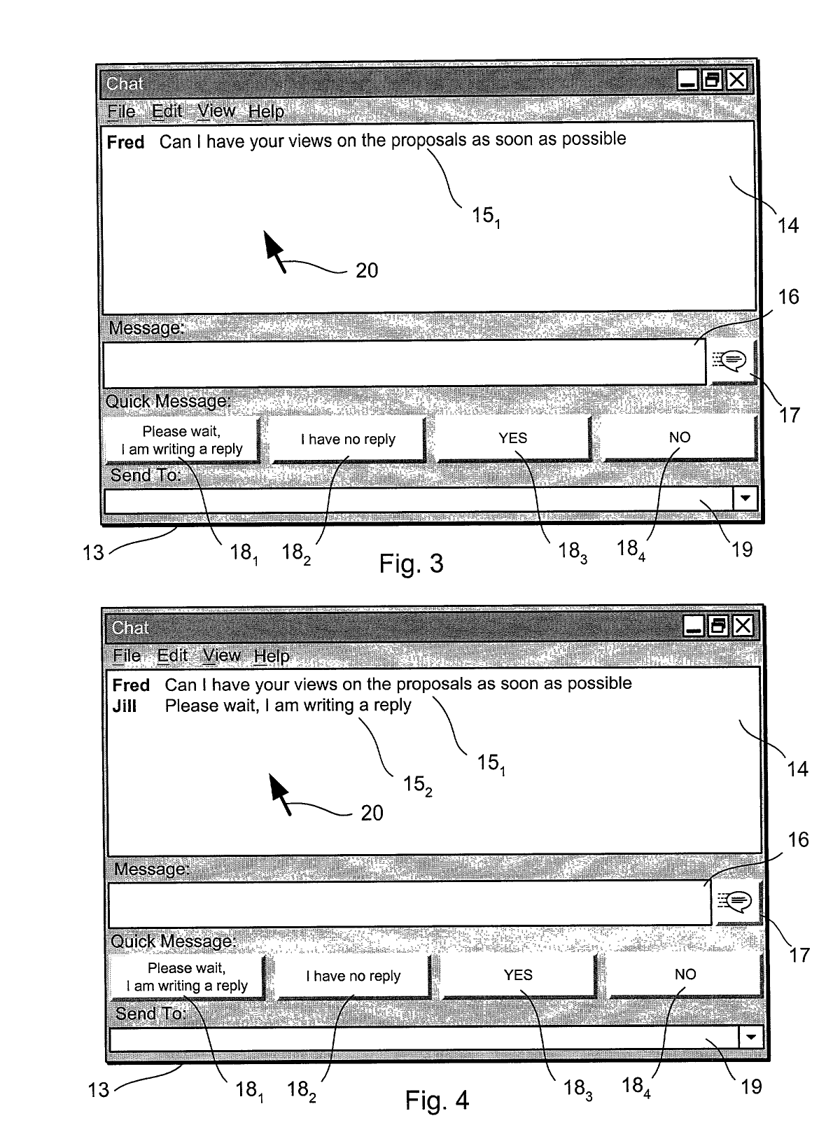

Referring to FIG. 3, the first and second computer systems 1₁, 1₂ load and run message exchange software, similar to Microsoft NetMeeting™ version 2.1. A user group is defined in a manner well known per se. In this case, the user group comprises the first and second users 1₁, 1₂.

A message exchange interface window 13 is displayed on the monitor 4 (FIG. 2) of each computer system 1₁, 1₂. The window 13 includes a message board 14 for displaying messages 15, a text editor 16 for entering and editing messages, a send button 17 for posting a message once prepared using a text editor 16, a plurality of buttons 18₁, 18₂, 18₃, 18₄ for sending predefined messages and an editor 19 for identifying recipients of the message. The window 13 is navigated using a focus 20, which in this case is a mouse pointer.

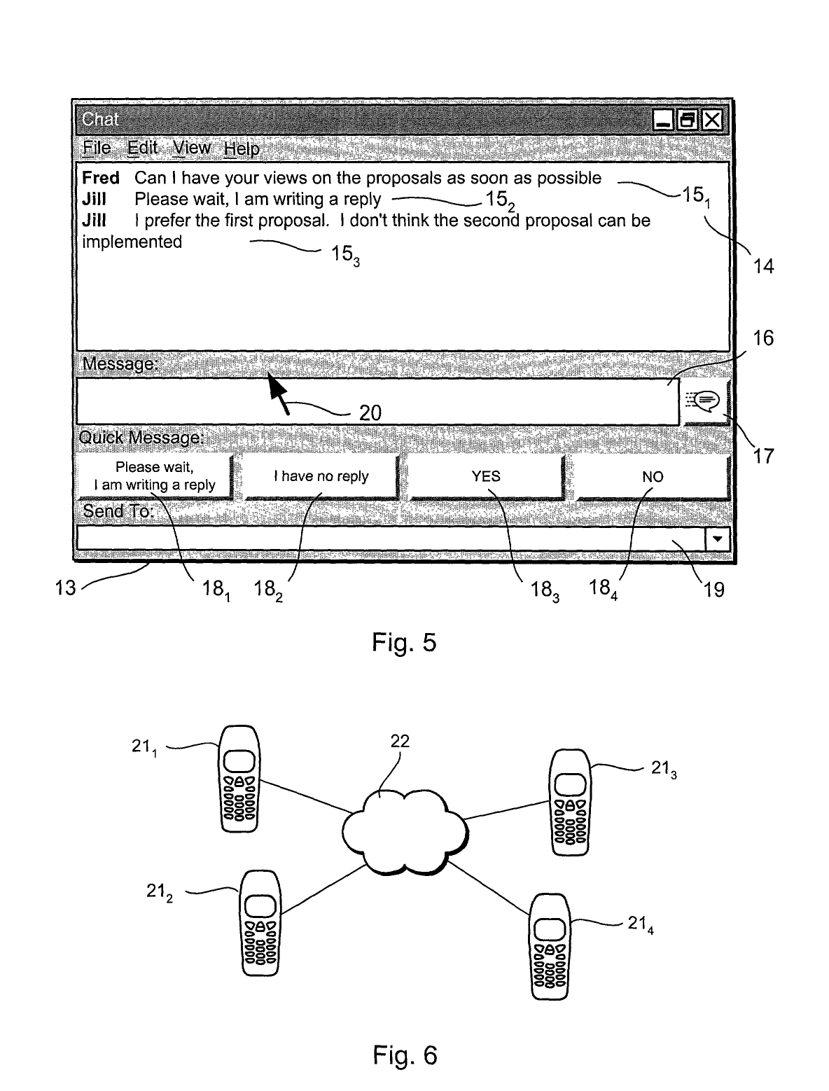

A first user, called Fred, using the first computer system 1₁ posts a message 15₁ to the message board 14, such as “Can I have your views on the proposals as soon as possible”. A second user, Jill, using the second computer system 1₂ reads the message 15₁ on the message board 14 and wants to reply to the message 15₁. However, she knows her response is lengthy and is likely to take some time to enter in the text editor 16. Therefore, she positions the pointer 20 over the first predefined message 18₁ using the mouse 6 (FIG. 2) and presses a button (not shown) on the mouse 6. This causes her computer 3 to post a message 15₂ “Please wait, I am writing a reply” on the message board 14, as shown in FIG. 4. Both Fred and Jill can view the messages 15₁, 15₂ displayed on the message board 14 at their respective computer systems 1₁, 1₂. Thus, Fred knows to expect a reply from Jill. Meanwhile, Jill prepares a reply. Using the text editor 16, she types a message “I prefer the first proposal. I don't think the second proposal can be implemented” and then presses the send button 17. Her computer 3 posts the message 15₃ on the message board 14, as shown in FIG. 5. It will be appreciated that while Jill is preparing her reply, Fred can send another message.

Thus, use of the predefined messages allow users to communicate more quickly and converse more fluidly. The messages also have the advantage of being uniform.

The buttons 18₁, 18₂, 18₃, 18₄ and the messages may be customisable by the user. For example, the user can add or delete predefined message, utilise icons and format messages, such as setting colours and font types and using italic and bold styles.

It will be appreciated that predefined messages can be included chat software provided by a web-browser or downloaded as a Java applet from a chat server computer.

It will also be appreciated that more than two users can engage in a conversation. For example, a third user can post messages and so a three-way conversation is possible.

In this example, all the users have equal status. Thus, a message is sent to each of the computer systems 1. However, it will be appreciated that one of the users can have a “master” status, in which case all messages are directed through their computer system 1. Alternatively, a server computer can be provided, such as one which is usually provided for chat rooms.

### Second Embodiment

Referring to FIG. 6, a plurality of mobile telephone handsets 21₁, 21₂, 21₃, 21₄ are connected via a public land mobile network (PLMN) 22. In this example, the handsets and the PLMN 22 conform to a so-called second generation (2G) specification, such as GSM. It will be appreciated that the handsets 21 and network 22 may conform to a 2½G or 3G specification.

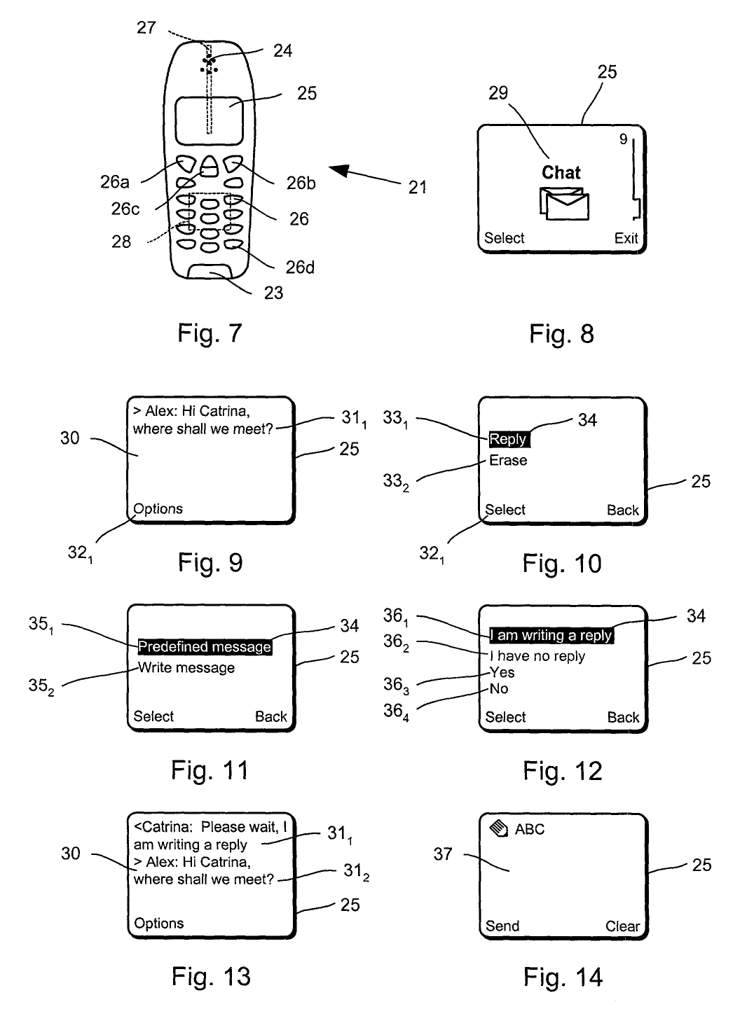

Referring to FIG. 7, a typical mobile telephone handset 21 includes a microphone 23, speaker 24, liquid crystal display (LCD) 25, keypad 26 and internal antenna element 27 which sends and receives radio signals to and from the PLMN 22. The keypad 26 includes first and second soft keys 26a, 26b, a bidirectional scroll key 26c and an alphanumeric set of keys 26d. The handset 21 also includes a microcontroller 28 which receives instructions from the keypad 26 and controls operation of the LCD 25. The handset 21 includes a chat messaging feature similar to that found in a Nokia 3110 handset using short message service (SMS) messages. However, according to the present invention the chat messaging feature is modified to provide predefined chat messages.

A process by which users of first and second handsets 21₁, 21₂ can engage in “chat” will now be described.

Referring to FIG. 8, each user enters into chat mode by selecting a “Chat” function 29 from a main menu displayed on LCD 25 using the scroll key 26c and the soft keys 26a, 26b (FIG. 7). This causes the handsets 21₁, 21₂ to load and run chat messaging software.

The first user, called Alex, sends a chat message to the second user, Catrina.

Referring to FIG. 9, Catrina's LCD 25 displays a message board 30 including Alex's message 31₁, namely “Hi Catrina, where shall we meet?” and a legend 32₁ “Option” associated with the first soft key 26a (FIG. 7).

Referring to FIG. 10, Catrina presses the first soft key 26a (FIG. 7) and is presented with options including a first option 33₁ to send a reply and a second option 33₂ to erase the message 31₁. A focus 34, in this case represented by inversion of the foreground and background colours, is controlled using the scroll key 26c. Selection is effected using the first soft key 26a, as indicated by the first legend 32₁.

Referring to FIG. 11, Catrina selects the first option 33₁ and is presented with further options including a third option 35₁ to use a predefined message or a fourth option 35₂ to write a reply message.

Referring to FIG. 12, the LCD 25 lists predefined messages 36₁, 36₂, 36₃, 36₄, namely “I am writing a reply”, “I have no reply”, “Yes” and “No”.

Referring to FIG. 13, Catrina selects the first message “I am writing a reply” 36₁. This is sent as a chat message 31₂ to Alex and is displayed on the chat board 30 on his LCD 25. Catrina's LCD 25 also displays the chat board 30 with her message 31₂.

Referring to FIGS. 10, 11 and 14, Catrina can follow up her predefined message 31₂ with one she composes herself by selecting the reply option 33₁, selecting the option 35₂ to write a message using a text editor 37.

Thus, the predefined messages 36₁, 36₂, 36₃, 36₄ allow users to communicate more quickly and converse more fluidly. This is especially useful since text messages are difficult to compose on mobile telephone handsets due to the restricted number and size of keys in the keypad 26.

Although the example describes only two users, it will be appreciated that more than two users may engage in chat.

It will also be appreciated that alternative user interfaces can be used, particularly to select predefined messages. In this example, the user interface includes the use of soft keys 26a, 26b, the scroll key 26c and the display of legends 32 associated with the soft keys 26a, 26b. However, the user can select predefined messages using so-called “quick keys”, such that a predefined message is selected by pressing a predetermined key. Thus, a first predefined message may be selected by pressing a key labelled “1” on the keypad 26. The user interface may allow selections to be made using voice commands and/or using a touch sensitive display.

It will be appreciated that many modifications may be made to the embodiments hereinbefore described. For example, any type of electronic device which can be used to communicate with another electronic device by means of real-time, text messaging can use predefined messages, such as PDAs and digital television sets.

The message board need not be text-based. For example, a text-to-speech converter may be used. Thus, while a user prepares a message, the message board may announce that a response is being prepared.

1. A method of exchanging messages using a commonly accessible message board, the method comprising:
presenting a user with one or more predefined messages and
receiving an input from the user selecting one of said predefined messages as a message for posting on said message board.

2. A method according to claim 1, further comprising posting said message on said message board.

3. A method according to claim 2, wherein said posting of said message on said message board includes sending said message to at least one other user.

4. A method according to claim 3, wherein said sending said message to at least one other user comprises transmitting said data over a communications network.

5. A method according to claim 3, wherein said sending said message to at least one other user comprises transmitting said data over the internet.

6. A method according to claim 3, wherein said sending said message to at least one other user comprises transmitting said data over a telecommunications network.

7. A method according to claim 3, wherein said sending said message to at least one other user comprises transmitting data as a short message service (SMS) message.

8. A method according to claim 3, wherein said sending said message to at least one other user comprises transmitting said data over a local area network.

9. A method according to claim 1, wherein said presenting said user with said one or more predefined messages comprises outputting graphical representations of said predefined messages to a display.

10. A method according to claim 9, wherein said outputting said graphical representations comprises displaying selectable icons using a graphical user interface.

11. A method according to claim 10, wherein each of said selectable icons include text of a respective message to be posted to said message board.

12. A method according to claim 10, wherein said selecting said one of said predefined messages includes locating a focus on a one of said selectable icons.

13. A computer program for performing the method according to claim 1.

14. An electronic device for exchanging messages using a commonly accessible message board, the device configured to present a user with one or more predefined messages and to receive an input from the user selecting one of said predefined messages as a message for posting on said message board.

15. A device according to claim 13, which is a computer.

16. A device according to claim 13, which is a mobile communications device.

17. A device according to claim 15, which is a mobile telephone handset.

18. A method of exchanging text messages comprising:
receiving a message; and
responding to the message by:
(a) selecting a predefined message and sending it, and thereafter
(b) composing a non-predefined message and sending it.

19. A method according to claim 18, wherein said sending of said messages comprise sending said messages to another user.

20. A method according to claim 18, wherein said sending of said messages comprise posting said messages to a commonly accessible message board.

21. A computer program for performing the method according to claim 18.

22. An electronic device for exchanging text messages, the device configured:
to receive a message and
to respond to the message by permitting the user to select a predefined message and send it, and thereafter compose a non-predefined message and send it.
